(19) United States
(12) Patent Application Publication
(10) Pub. No.: US 2012/0010922 A1
(43) Pub. Date: Jan. 12, 2012

(54) CO-CREATION DESIGN PROCESS FOR CREATING CONSUMER GOODS

(76) Inventor: Kevin Smith, Troy, MI (US)

(21) Appl. No.: 13/179,019

(22) Filed: Jul. 8, 2011

Related U.S. Application Data
(60) Provisional application No. 61/362,983, filed on Jul. 9, 2010.

(51) Int. Cl. G06Q 10/00; G06Q 30/00

(52) U.S. Cl. 705/7.32

(57) ABSTRACT

A method and tool for enhancing customer related research with product manufacturers has been provided. Consumers are invited into a design experience by inputting personal data and product design preferences in order to create a profile. A consumer is then invited to provide specific product design preferences and they can interact with a design tool in order to co-design new products in collaboration with designers. The consumer's data is then aggregated and provided to designers and marketers who will use the information for the next stage of product development.

### CROSS-REFERENCE TO RELATED APPLICATIONS

The present application claims priority to U.S. provisional application Ser. No. 61/362,983 filed on Jul. 9, 2010 and is incorporated in its entirety by reference herein.

### BACKGROUND OF THE INVENTION

The present invention relates generally to a tool and process for creating new products for consumers. In particular, the integration of crowd sourcing and co-design methodology that allows consumers to have an active voice in the new product design process. By allowing consumers to have an active voice in the design process, the design cycle is drastically shortened, thus bringing efficiencies to the process of bringing new products to market.

Traditionally, product research is rooted in the company controlling the process of what is made for the consumer. Research events can be held at various junctions along the development of a product in order to help inform the company and adjust company-driven designs. Design research events can then be held downstream where consumer insight can oftentimes only help designers make adjustments to their existing design ideas and the consumer is held at a distance in terms of collaborating, co-creating, or co-designing a product.

For example, traditional stages of new product development can first include creating conceptual sketches of potential products. These sketches can be presented on theme boards where an informal selection process occurs with the design team picking their favorite sketches. Management then reviews the concept sketches which results in 2D CAD models being produced for marketing research purposes. Using these 2D CAD models, a market research firm then shows these concepts to members of the public for their comments. The concepts can then be reworked which can later be presented again with the consumers' feedback being taken into account by market research firms. Thereafter, full-size models of products, made of clay, stereolithography, or the like, may then be generated of the most popular design ideas. Often these full-size models are created using CAD data to create the finished model. 3D market research then ensues utilizing the full-size models where the members of the public can comment. The management team then gives final approval to the 3D model and then a feasibility development study is conducted of the chosen concept.

The problem with the traditional style of developing products is that the product often is launched without critical consumer input. If the product is not embraced by the public, then it may not sell thus resulting in significant losses of revenue. This could be avoided with an improved new product design process.

The design process of complex consumer products, for example vehicles, often follow the above-mentioned steps. It will be appreciated that it would be desirable to provide a new product development process that involves the consumer earlier in the process so that they have a voice in the early development of new products. It would also be desirable to provide a more cost-efficient process of developing new products that integrates consumer input, designer involvement, marketers and researchers together in a co-design process so as to aid in the development of new products. It would also be desirable to shorten the timeline for developing new products and thus bring greater cost efficiencies to the process.

According to one aspect of the present invention, consumers are invited into a design event where they interface with computers to provide personal information, product preferences, and a selection of certain design elements of potential new products. The consumer is then invited to engage in a co-design process whereby the consumer can select from further design concepts that have been generated based upon the consumers design criteria. A resulting design emerges that includes the consumer's influences which means the product may be more successful in the marketplace.

### BRIEF DESCRIPTION OF THE DRAWINGS

The present invention is illustrated by way of example and is not limited in the figures of the accompanying drawings in which like references indicate similar elements.

FIG. 1 shows a timeline for a conventional new product design;

FIG. 2 shows a timeline for developing a new product using the present invention;

FIG. 3 shows an opening step for designing a new product;

FIG. 4 shows providing instructions to a consumer at the beginning of a design event;

FIG. 5 shows the step of a consumer logging into a co-creation computer system;

FIG. 6 shows a consumer inputting her data into a computer system;

FIG. 7 shows a consumer presented with a choice of different products;

FIG. 8 shows the consumer interacting with the computer tool to provide design influences;

FIG. 9 shows a consumer being prompted with information;

FIG. 10 shows a consumer participating in a survey;

FIG. 11 shows a product a consumer has selected through the design process;

FIG. 12 shows a flow chart of a co-creation process at a design event;

FIG. 13 illustrates a dash board a consumer would experience during the co-creation process;

FIG. 14 shows a registration screen shot a consumer would interact with while participating in the co-design process;

FIG. 15 shows a screen shot of the consumer's profile;

FIG. 16 shows a screen shot a consumer sees in the sketch phase of the co-creation process;

FIG. 17 shows a screen shot a consumer sees concerning her personal information;

FIG. 18 shows a screen shot a consumer interacts with for inputting survey information;

FIG. 19 shows a screen shot a client sees, which illustrates the results of the consumer data that was input during the previous screen shots; and

FIG. 20 shows a flow chart of the steps of an alternative co-creation process where the design event is conducted via the internet.

### DETAILED DESCRIPTION OF THE PREFERRED EMBODIMENTS

Embodiments of the present invention provide, amongst other things, a computer based design tool for aiding in the creation of consumer goods. Consumers may be invited into an on-site design event or invited via the internet to participate in the process of designing new products. While examples are given utilizing the present invention in connection with automotive applications, it will be appreciated that the present invention can be utilized wherever new products are to be developed, or redeveloped. It will be appreciated that the present invention can be utilized where it is desired to provide efficiencies in the development of products.

In the following description, for purposes of explanation, various details are set forth in order to provide a thorough understanding of the description of the present invention. It will be appreciated, however, to one skilled in the art that the inventions can be practiced without these specific details. Various embodiments of the present invention are disclosed including methods of a co-creation process.

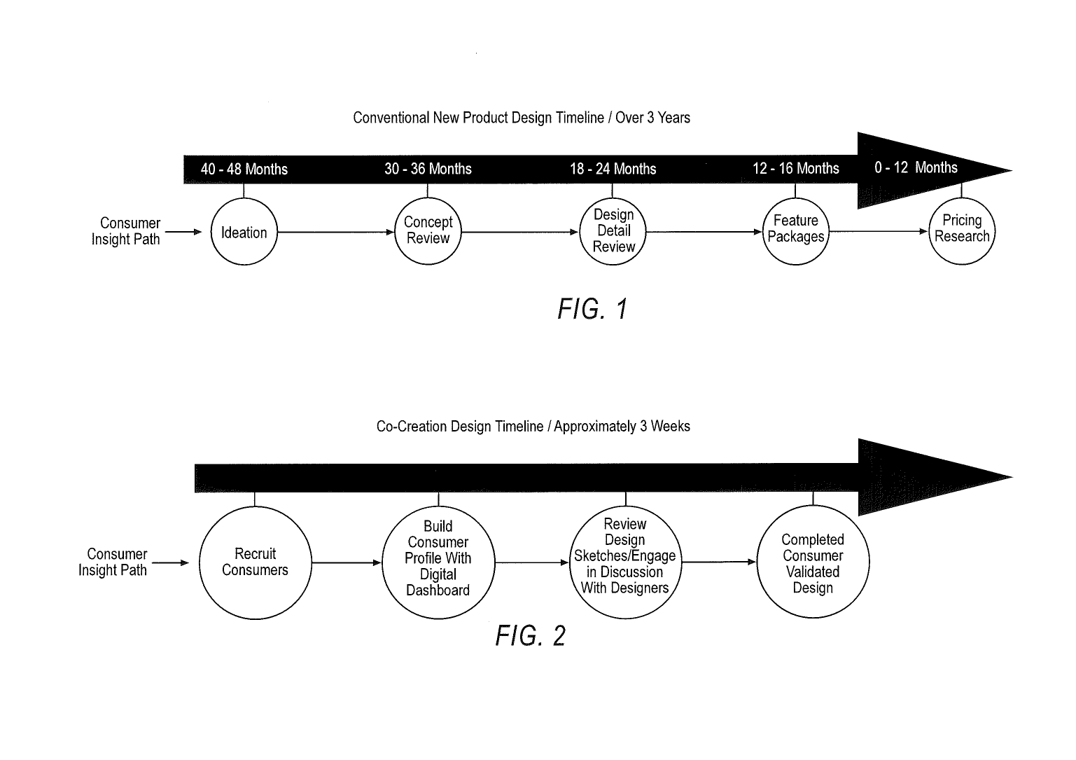

FIG. 1 of the drawings illustrates a typical timeline for developing a new product, for example a vehicle. The typical timeline can consume several years of resources and failures which can be a very inefficient use of resources. By contrast, FIG. 2 illustrates a potential timeline for the present invention which contemplates a more refined and efficient methodology for designing new products. Instead of taking years to develop a new product, the present invention contemplates creating new products within a matter of weeks or even hours. In particular, the consumer's insight path for developing a new product using the present invention includes recruiting virtual voice consumers that can participate in the design process. A consumer profile is then generated using tools, for example, an on-line questionnaire that can be accessed through a dashboard. A consumer then can review sketches and even engage with designers via live or other on-line communication. A consumer can then review revised sketches of products that may be in 3D and provide yet additional feedback in a virtual reality setting which results in a validated consumer design.

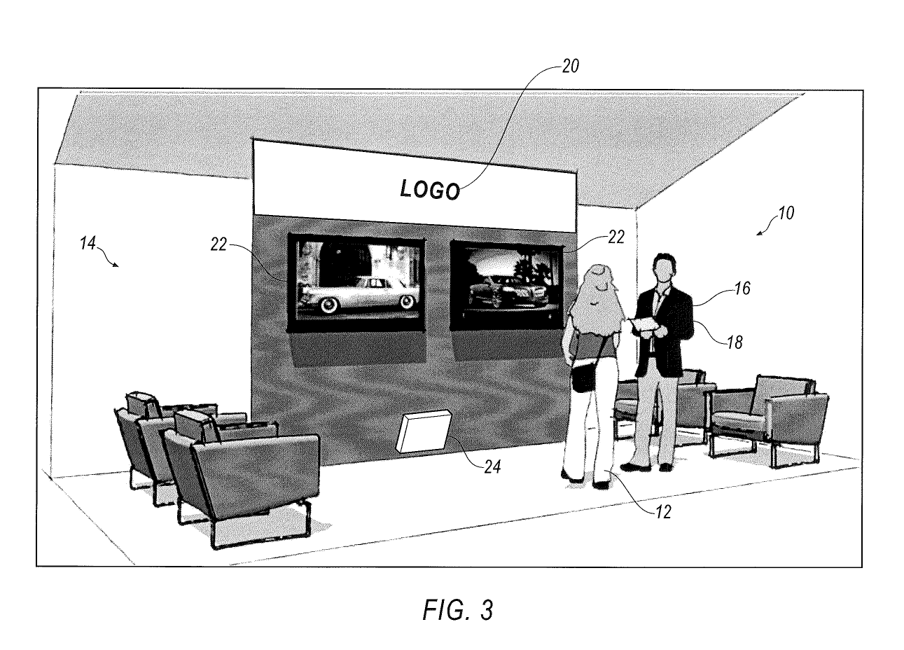

FIG. 3 illustrates an early step in the co-creation process 10 where a consumer 12 is invited to an event 14. Event personnel 16 provide a computer 18 that is operable to allow a consumer 12 to input their data such as personal information, product preferences, or other significant information. At the event 14 a company logo 20 and product depictions 22 may be displayed in order to create the environment for the consumer. A main computer 24 can be provided and be used in the event for compiling and processing data from consumers. Software 111 is operated on the computer 24 and creates an interface, dashboard 96 and compiler of data that may be later studied.

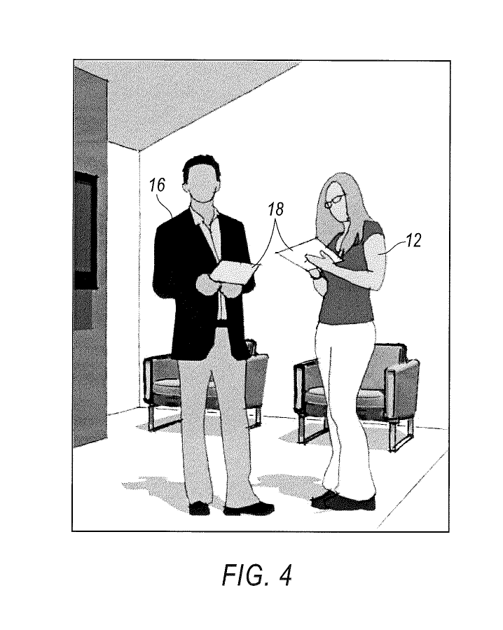

FIG. 4 illustrates a consumer 12 and the event personnel 16 with their computer 18 during the process of logging into their computer to begin the co-creation process. The computers 18 may be tied into a main computer 24 via wireless, or other conventional means, so as to allow the consumer's data to be housed, aggregated, and analyzed.

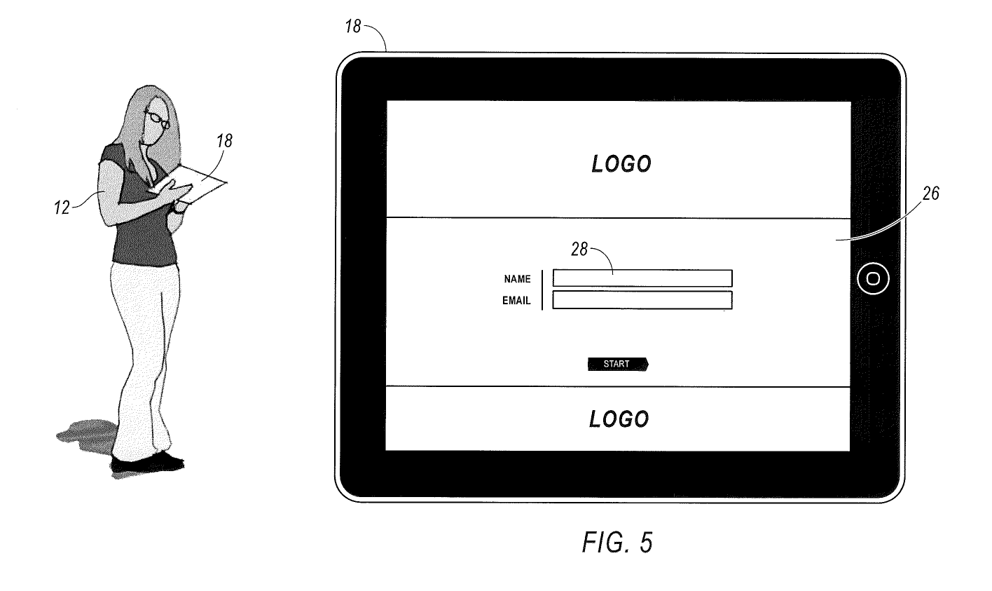

FIG. 5 illustrates a log in screen 26 that the consumer 12 sees when viewing a computer 18. Basic information 28 can be input by the consumer which in turn is used to begin the process of starting her consumer profile.

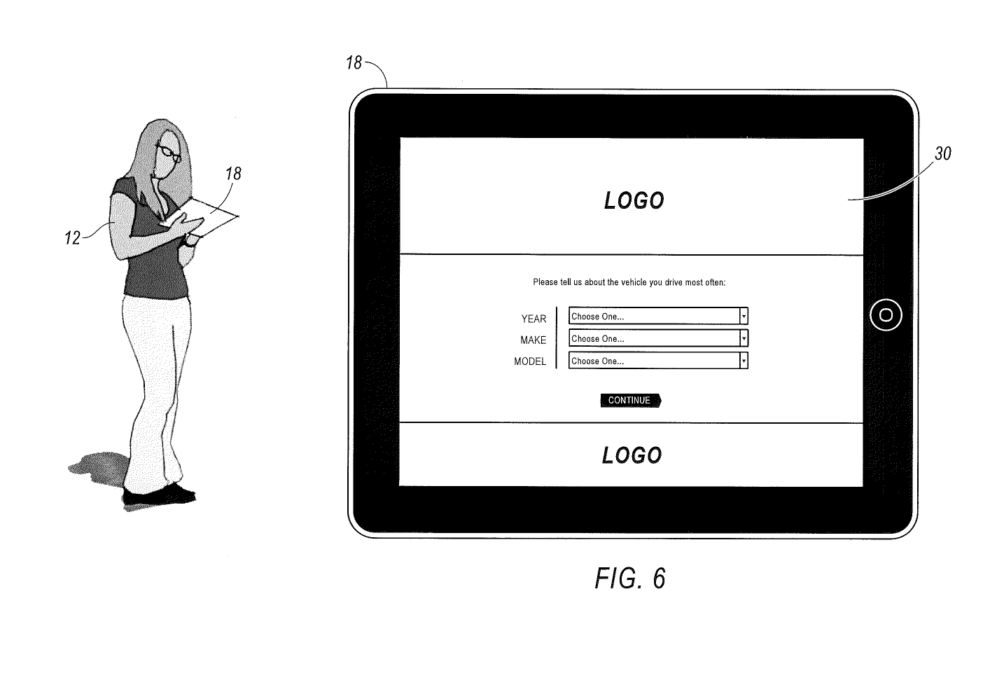

FIG. 6 illustrates an input screen 30 on the computer 18 that allows a consumer to input basic information about current products the consumer is using or has used. For example, in the depicted screen 30, the consumer 12 is inputting data about the type of vehicle she drives most often. This data goes into the consumer's profile for later evaluation. It will be appreciated that other screens 30 may be provided that probe other criteria about the consumer.

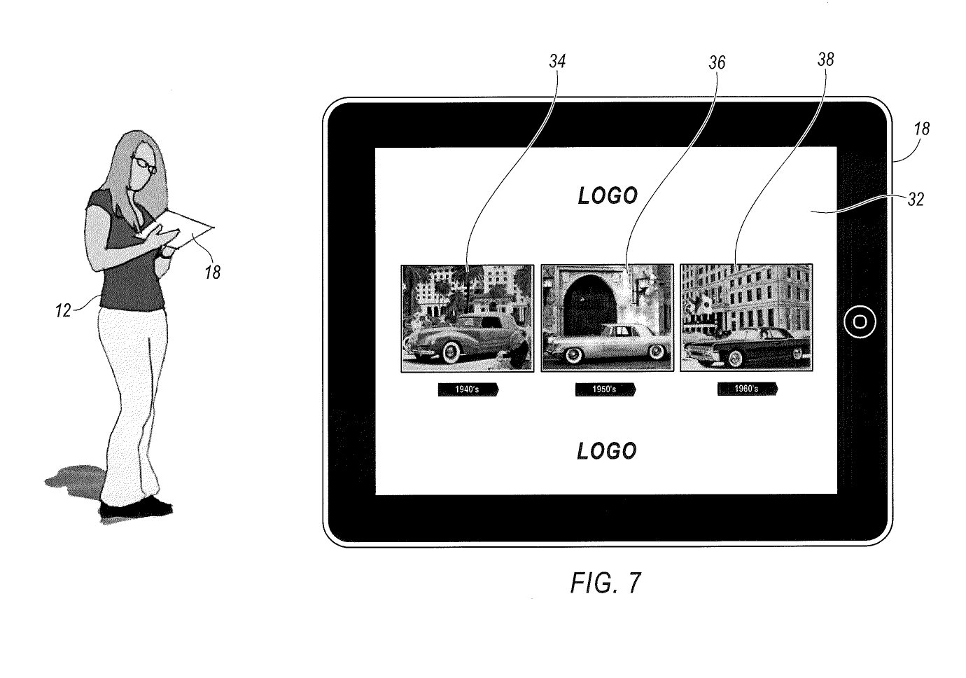

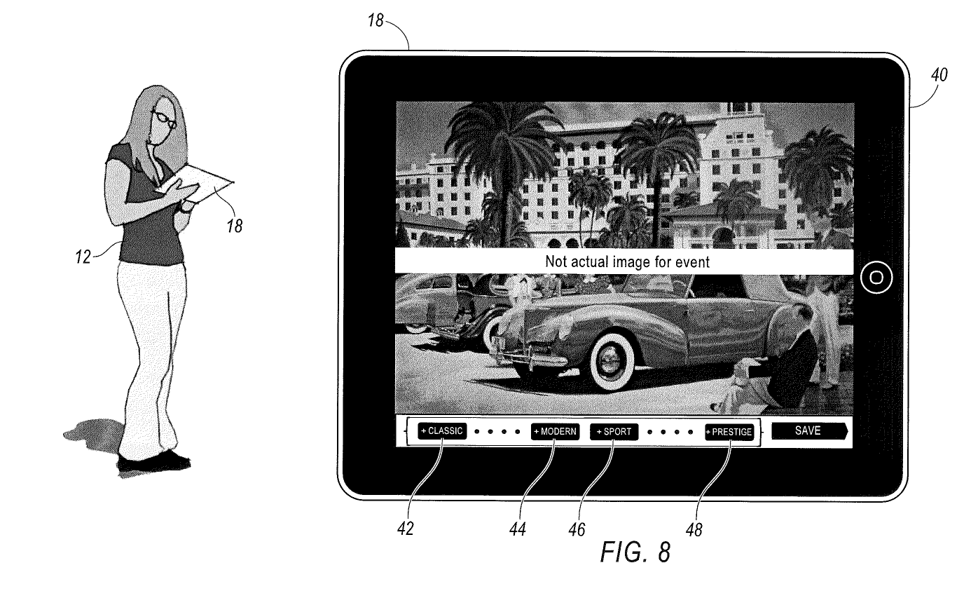

FIG. 7 illustrates an interface screen 32, on computer 18 which illustrates design options for a product. For instance, examples of various cars can be given to the consumer 12 allowing her to select a preferred style. While three different design options are illustrated, it will be appreciated that more or less design options may be depicted thus allowing the consumer to have a varied selection of design choices. This step of the design process attempts to learn more information about the consumer's product design choices which will later aid in the design process. In this particular exemplar, a consumer could select options 34, 36 or 38.

FIG. 8 illustrates an output screen 40 the consumer 12 would see if she chose the first option 34 which could be a 1940's style vehicle. The consumer is provided with different design choices for example, classic 42, modern 44, sport 46, or prestige 48. The consumer 12 may select one of these choices to provide their particular design preference as to how they would like to see a product designed and/or built. It will be appreciated that these design attributes can be particular for any given new product that is to be designed. It will be further appreciated that the consumer may go through a series of these output screens whereby the consumer can input their feedback as to various design attributes that they would like to see in a given product. This step may continue until the consumer has responded to all queries pertaining to this particular design. The various inputs by the consumer are then saved in the computer 18 which in turn may eventually be stored in the main computer 24 for later processing by the software program 111.

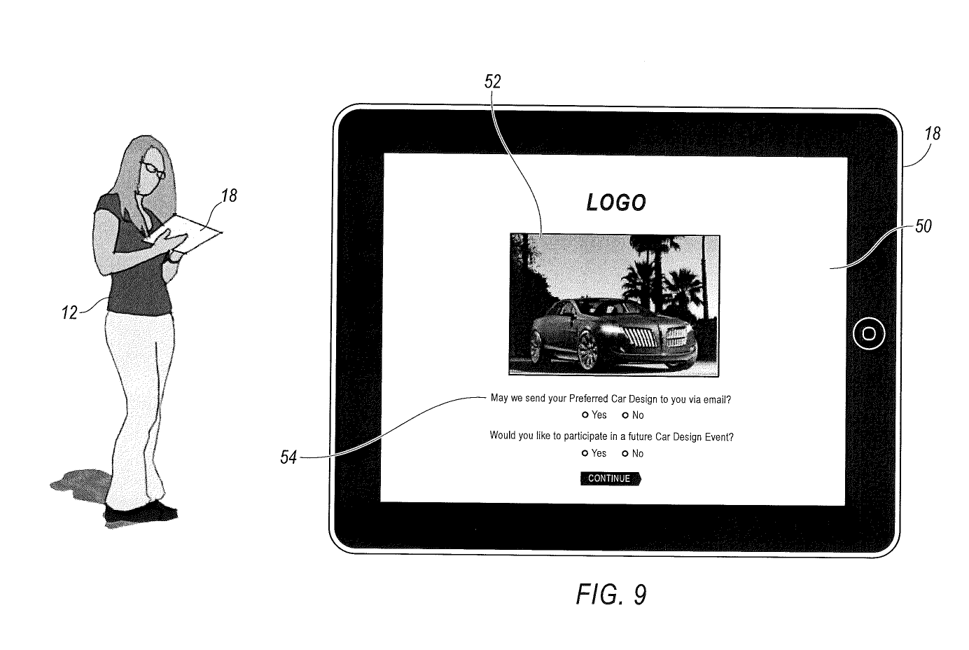

FIG. 9 illustrates an output screen 50 on the computer 18 that the consumer 12 sees after she has provided her design attribute influences. The product she has designed through her co-creation process is illustrated 52 where she is then prompted 54 and given the opportunity to receive a copy of her design along with an invitation to engage in future design events.

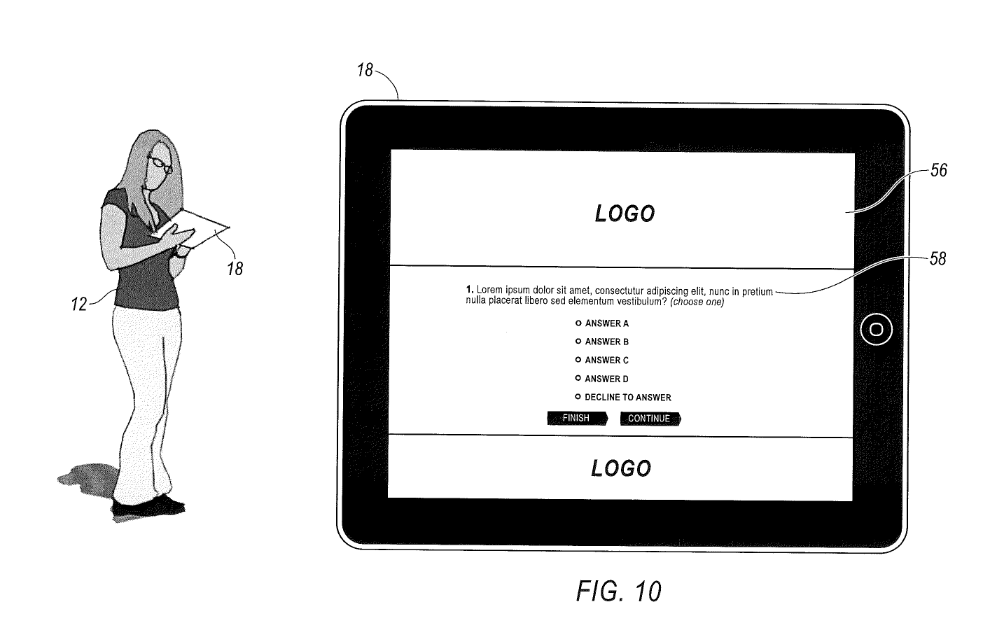

FIG. 10 illustrates an output screen 56 that the consumer 12 sees during a survey 58 that is conducted. The survey data becomes part of the consumer's profile and will assist designers, marketers, and manufacturers with information about a consumer's preferences. While only one screen is presented, it will be appreciated that several survey screens can be utilized for the consumer to engage.

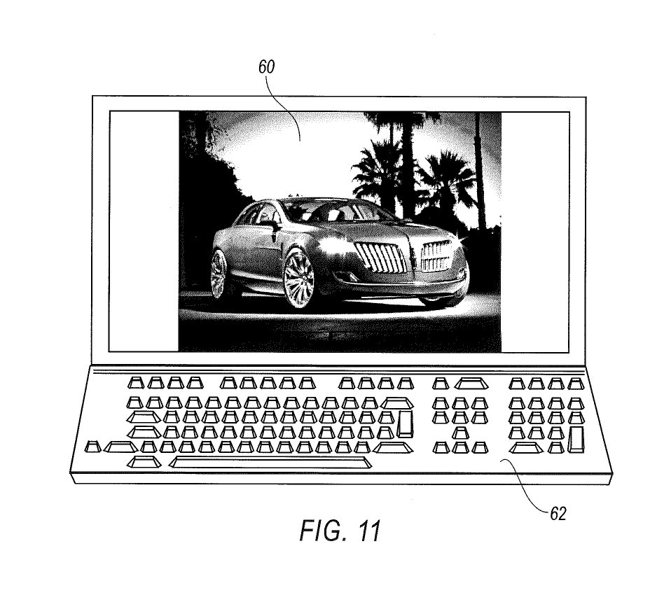

FIG. 11 illustrates feedback 60 a consumer 12 may receive to her personal computer at home after a design event has concluded. The consumer may keep a copy of the products she had aided in designing and this may be sent via email from the main computer 24 that gathered her data. It will be appreciated that the consumer may receive other feedback 60, invitations, promotions, or indicia that engages or invites the consumer to later be involved with a marketer, researcher, or company that is interested in developing new products.

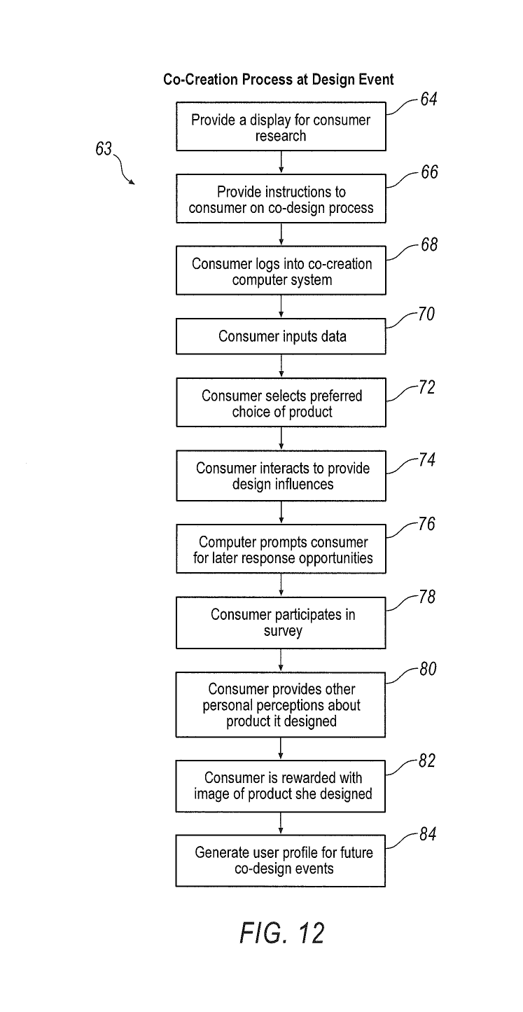

FIG. 12 illustrates a flow chart for the steps involved in a co-design event where the consumer attends an on-site event and participates in a design process. This process or phase can be referred to as crowd sourcing. During the crowd sourcing phase consumers are identified, and brought into the design process and if desirable, a marketing firm can later call back that consumer for yet further marketing research. Crowd sourcing may include all or only certain aspects of the following process and it will be appreciated that it may include yet other steps. FIGS. 3-11 illustrate one potential crowd sourcing 63 methodology.

Crowd sourcing may begin with first providing a display for consumer research 64 where consumers are brought into the event. Consumers may or may not have already been screened to see if they match the profile of a potential participant. Additional screening may be employed if necessary. The next step is to provide instructions 66 to attendees on the co-design process. Consumers are shown how to use the computer 18 and they are invited to participate in a new product design process. Consumers are then given the opportunity to log into the co-design computer system 68 where they input their name, email, and other critical information.

The next step is when the consumer inputs additional personal data 70 about their personal design choices for the product at issue in the marketing research survey. Next, the consumer is given various options to select preferred products 72 that contain attributes of their preference. This step allows a consumer to now start to become part of the design process where she can provide her product design preferences and influences. The consumer then is provided with yet additional design options which allows her to interact to provide additional design influences 74. Once a consumer has input her design influences, she is prompted to participate in later response opportunities 76 that will allow her to receive follow up information about this particular design process. The consumer could be invited to interface with a designer via online or live in person which allows for the consumer's voice and design influences to further impact the design process. The consumer may then be provided with an opportunity to participate in a survey 78 and provide yet additional personal information on her perceptions about the product she just aided in designing 80. The consumer 12 may be rewarded for her efforts by being provided with an image of the product she designed 82 or she may receive other incentives. And finally, the consumer may then be provided with her user profile which she may interface with for future co-design events 84. The user profile could be housed on a computer 24 and accessed by the consumer at remote locations. The consumer could later, engage in yet an additional design process.

The prior description referenced a co-design process 10 where a consumer may be invited into an event at a location so as to provide her profile and design choices to aid in the co-design process. However, it will be appreciated that a consumer could engage in the co-design process 10 via the internet without actually attending an on-site location. For example, a consumer could be provided with an invitation to be brought into an online computer research or design event thus allowing her to provide her valuable design influences which in turn could be used by designers, marketers, researchers, or computer products companies. The following description provides an exemplar of one possible way a consumer could participate in the co-design process 10 via the internet. It will be appreciated that the present invention contemplates other methods of execution apart from those shown.

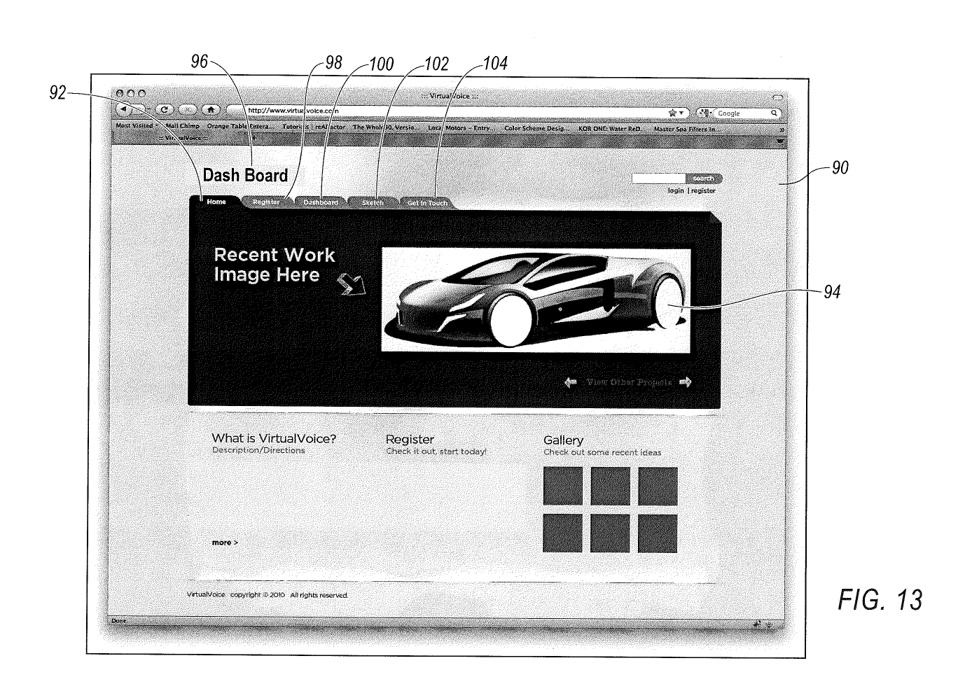

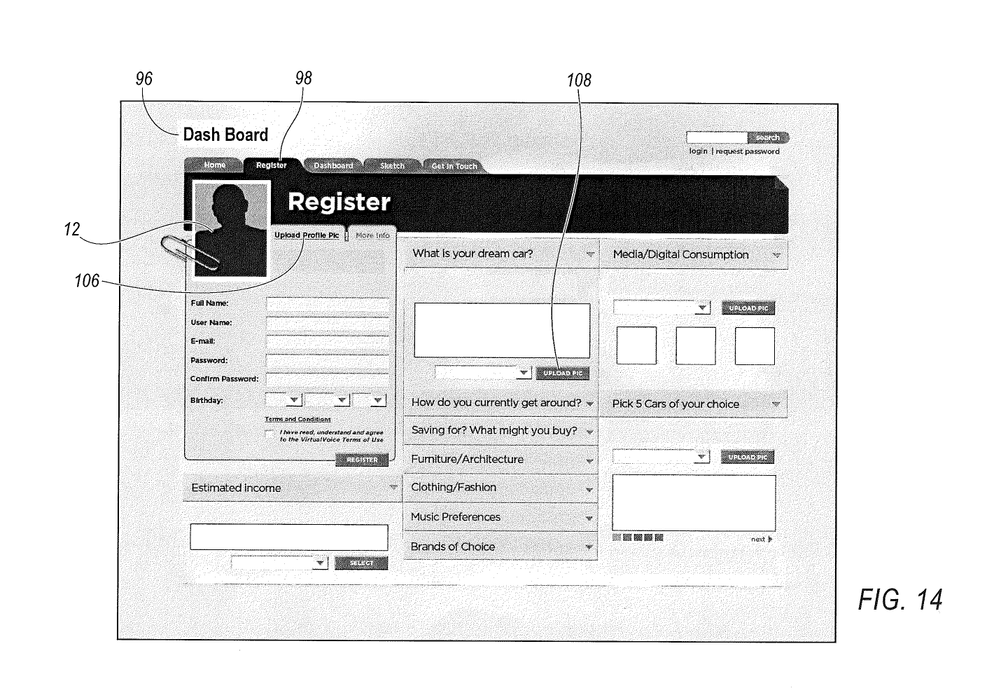

With reference to FIG. 13, a web page 90 is provided which can operate as a home page 92 for a consumer 12 to initially interface with during this design process. While a vehicle is illustrated, it will be appreciated that any consumer product 94 may be involved wherein the consumer's input is being solicited. A dashboard 96 of the webpage 90 may be provided and it could have a series of tabs or pull down menus such as a homepage 92, a registration page 98, a personal dashboard page 100, a sketch page 102 or a get in touch information page 104. It will be appreciated that other tabs may be available on the dashboard 96 and it can be tailored to meet a researcher's needs.

FIG. 14 illustrates an example of a possible registration page 98 on the dashboard 96 where a consumer 12 can input her personal information and begin to build her profile 106. Background information about the consumer's income, current products it uses, potential buying behavior, and the like may be presented. A consumer may be able to upload 108 information about their particular attributes which will aid the marketer in learning more about the consumer. This client relational management or CRM data will allow the marketer to get to know the consumer better which will aid in the co-design process. It will be appreciated that page 98 and the other pages discussed herein can be tailored to embody other consumer attributes.

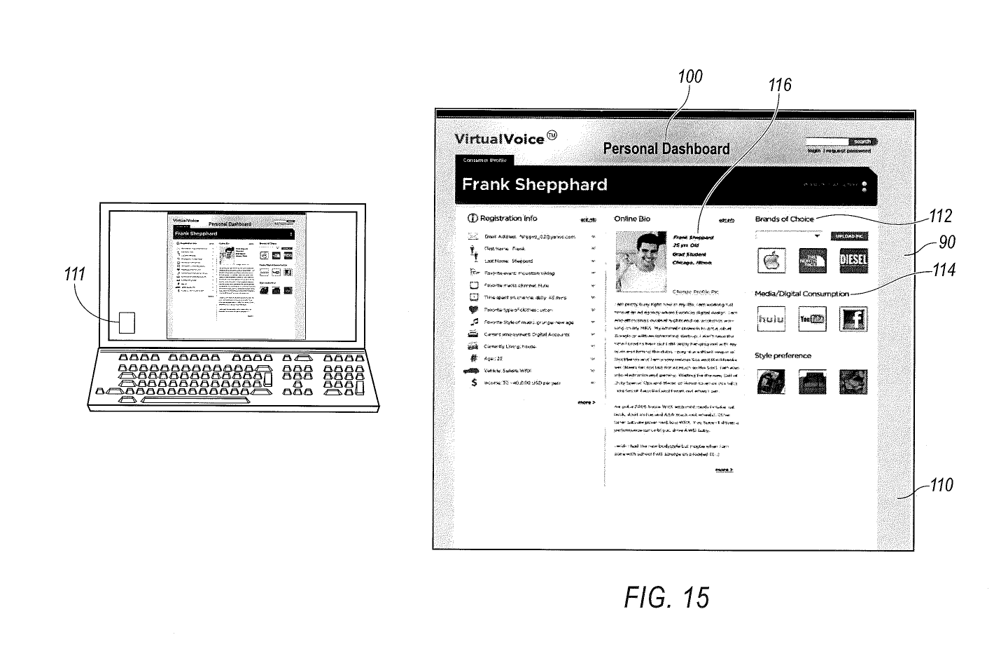

FIG. 15 illustrates a screen 110 when the consumer depresses the personal dashboard button 100. The personal dashboard 100 is generated by software 111 that can be operating on the main computer 24. The software aggregates the consumer's data, 28, 70, 78, and the like, that has been warehoused on the computer 24. The personal dashboard 100 can be customized by the consumer and it shows their brands of choice 112, their social media usage 114, biographical information 116. The information on the personal dashboard 100 can be shared with the marketer to allow them to become more familiar with the consumer and her design choices. This invention includes a co-design process set of tools that involves the consumer long after an initial design event. In fact, the consumer, after having completed the co-design process 10 could be invited back to a personal setting with the designer where she could be shown actual built models that may reflect her co-design choices. She could then provide further feedback.

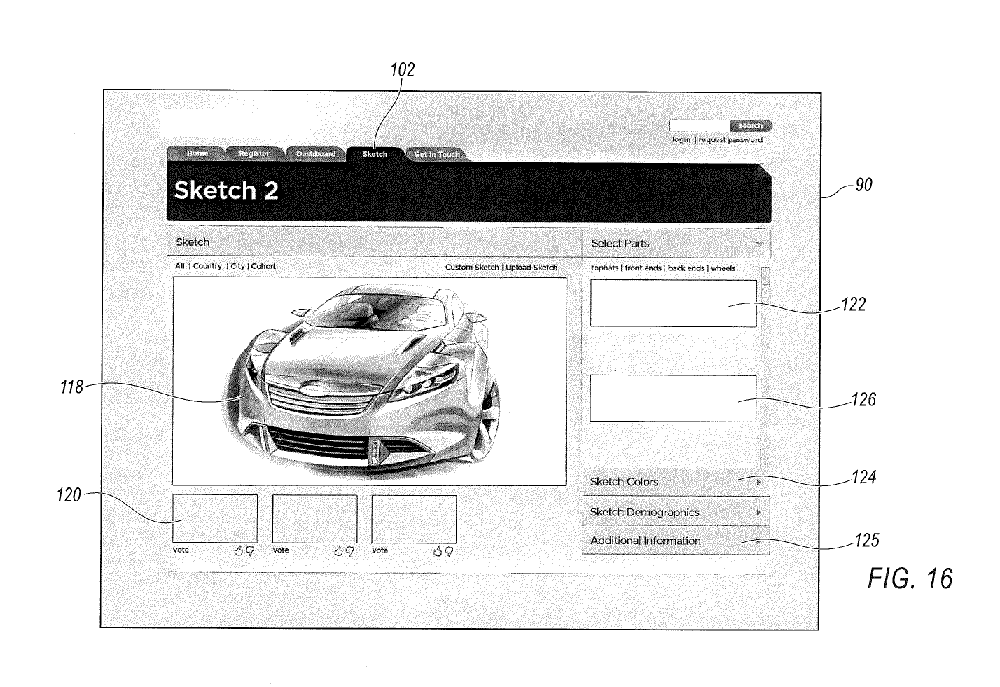

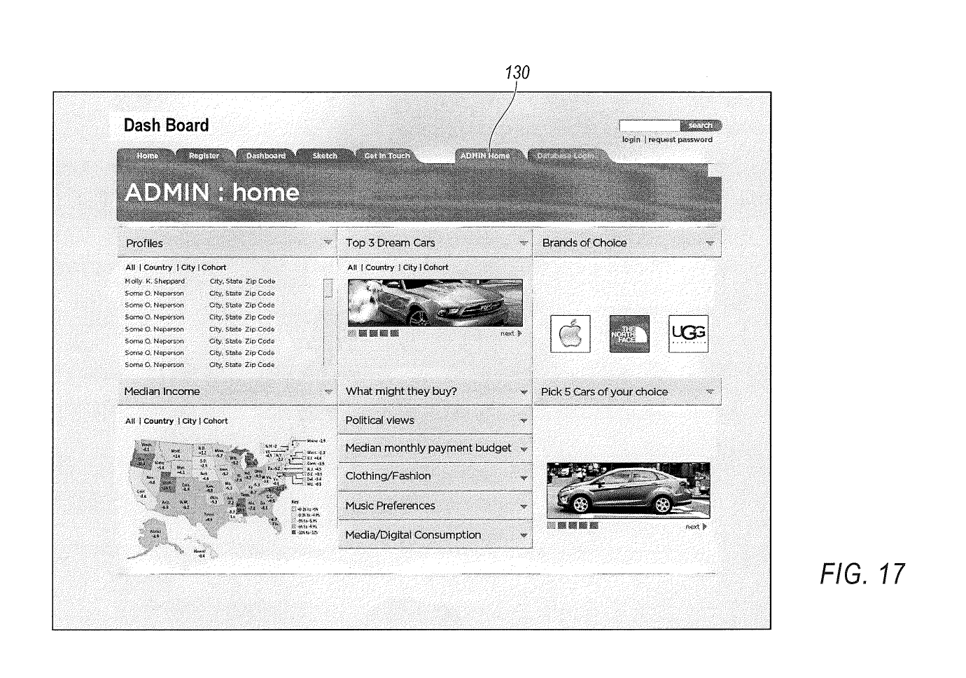

Similar to the prior design input screen shot, FIG. 8, FIG. 16 provides an on-line sketch page 102 which acts as a human interface that allows the consumer via online and/or in a live setting, to provide her design input. A go-to-meeting™ or the like could be used to allow for real time co-designing. The consumer could chat 126 with a designer directly, give design inputs directly, or even provide visual images of her own concepts she would like to see considered. In this regard, a digital drafting tool 125 could be incorporated or provided under its own tab or under the Additional Information tab. This tool 125 could allow a consumer 12 to directly input her design concepts into the process or system. Those design concepts could be depicted on a product image 118. The consumer can review those product images 118 and she can vote 120 as to whether she approves of the design or not. The consumer may also provide other design feedback and influences 122 and other design criteria 124 to aid in the design process. This information becomes part of the consumer's profile data. This direct engagement between consumer and designer upstream of the product cycle enhances product development. The sketch page 102 is an interactive design tool that can operate in real time on a virtual network wherever a consumer can log onto the internet.

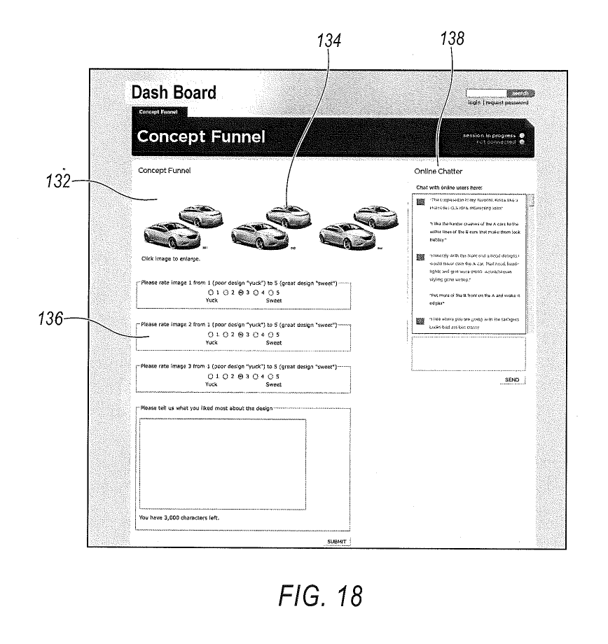

FIG. 17 illustrates a screen shot of the admin page 130 which is a general page that allows the consumer to access different categories of information they may be interested in reviewing or providing their thoughts thereabout. This portion of the dashboard provides the consumer various options for gathering and inputting more data such as the screen shown in FIG. 18.

FIG. 18 illustrates a consumer survey input screen 132 where a consumer may be shown a number of product images 134, for example vehicles, and the consumer can be asked a series of questions about their desires and feelings about those images. The consumer's response to those questions 136 are transferred to the main computer 24 where they may be later processed, aggregated, studied, reported, etc. The consumer has the option of being interfaced with an online chat feature 138 which could allow the consumer to interface directly with a designer so as to provide input directly in person. This dashboard allows the voice of the consumer to be quickly and directly related to a design team member so as to provide the designer with consumer's input about the product design being presented to the consumer. By providing the consumer's voice early in the design process, the designer can more easily respond to the consumer's input which in turn speeds up and aids the product generation process. This information will help marketers and researchers in bringing new products to market that have the consumer's input being provided early in the design process.

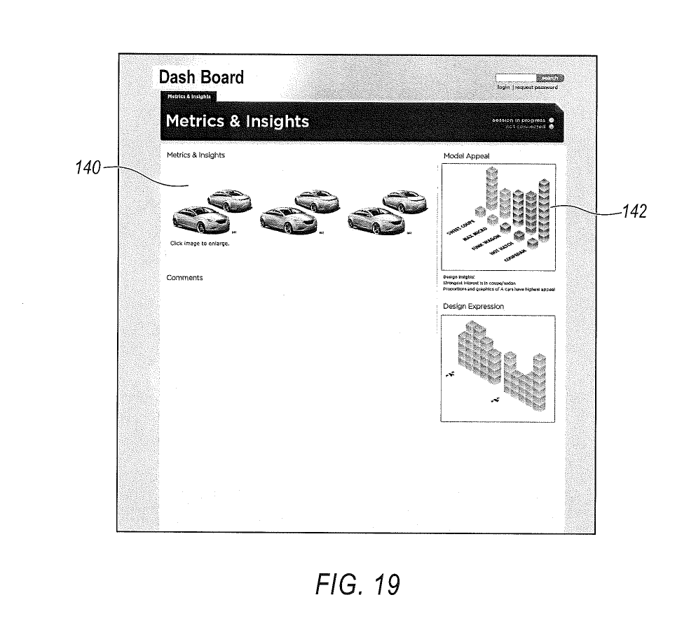

FIG. 19 illustrates a screen shot 140 that a client, such as a car company or other consumer goods company, could see that depicts aggregated data 142 that has been accumulated from the prior consumers who have taken surveys, for example the survey shown in FIG. 18. The client can see this aggregated data which represents a tabulation of the results based upon information from the various consumers who have participated in the co-design process and who have input data via the co-design process 10. It will be appreciated that the output data as depicted in FIG. 19 can be illustrated in many different ways, and the present invention can be modified to present the aggregated data 142 in methods that are desirable to a company that is using the present invention.

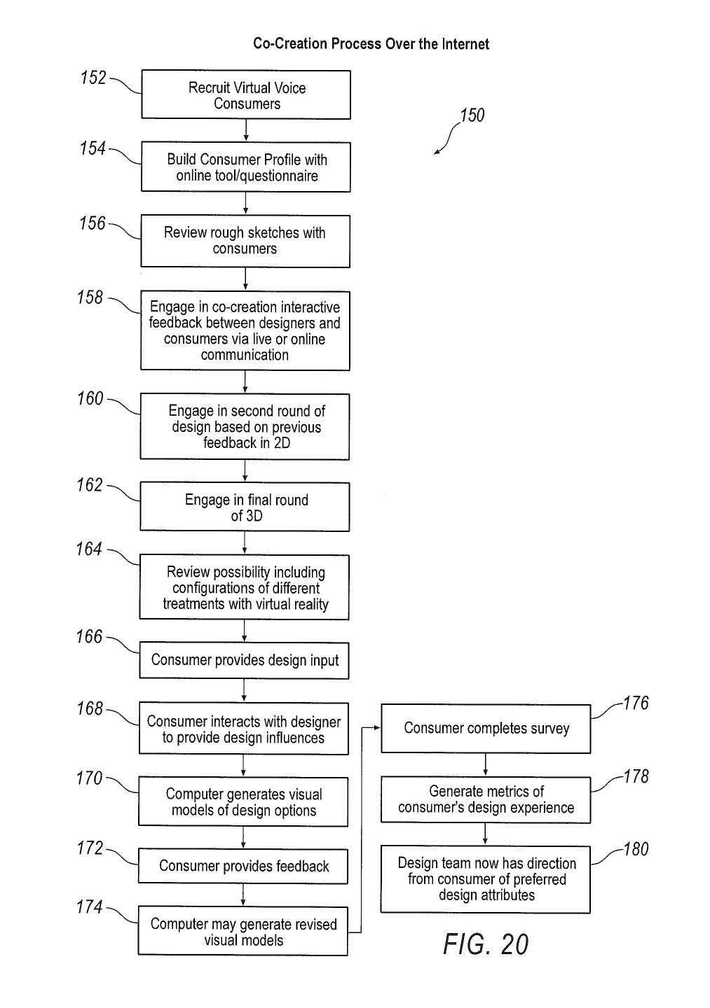

FIG. 20 illustrates a flow chart of a co-design process 150 that utilizes a web-interface for consumers to engage to input their design preferences. With reference to FIG. 20, a process 150 for co-designing a new product, includes the steps of providing a website with a dashboard for a consumer to use 152. The dashboard may be comprised of several screens such as log in, registration, home, personal dashboard, sketch, get in touch, etc. The dashboard creates an interface for the consumer to engage in the co-design process via the web or other digital media. The next step includes providing a computer for a consumer to log onto the website 154. The computer could be a portable device that would be easy for a consumer to handle during a design event, or could be a desktop computer thus allowing the consumer to participate in the design event while at home.

The next step includes providing a website having an interface that is secured to a cloud 156. The interface communicates with the website and the outside data storage medium, such as a cloud 156. It will be appreciated that the present invention contemplates storing the data on an internal server that could be operated by a marketer, researcher, product developer, or a manufacturer. The next step includes providing a cloud for hosting virtual data on a server 158. By providing a cloud, the consumer's data can be cultivated from any point where internet service is available to the consumer. Thus, a marketer could be hosting its website in one country, while allowing a consumer from another country to access the website and engage in the co-creation process. It will also be appreciated that the researcher could host its own server as well as its own website and have local control of the data that is collected from the consumer.

The next step includes recruiting consumers to participate in a co-design process 160. As with any survey, it is important for recruiters to select consumers who will be appropriate target participants for a particular product that may be at issue. Once a consumer has been recruited, they can be invited to join in the process by being given a link to the website along with the appropriate passwords.

Next, a consumer logs into and then registers with the website so as to provide access thereto 162. Once a consumer has logged into the system and is online, they are then invited to generate a consumer profile 164. The consumer profile allows the designers and the marketer to probe the consumer for relevant information pertaining to the product yet to be designed.

Next, the consumer provides design input 166 by responding to questions they are given. The consumer's response to these design inquiries will provide consumer design preference information that designers and marketers in turn, can use to aid in the design of new products. The consumer may be given several prompts to respond to that will provide design that particular consumer deems important to him or her. This then sets forth basic design preferences that a designer can then consider at a later stage of the design process.

Next, the consumer interacts with a designer to provide further design influences 168. This interaction allows a designer to be more interactive which allows a consumer to be closer to the design process. By bringing the consumer in closely to the design process at the front end of the development of a new product, the designer, marketer, and researchers are more likely to bring products to market that are more in line with consumer preferences.

The next step involves the computer generating visual models of various design options 170 that have taken into consideration the consumer's design influences. It is possible that multiple visual models may be generated by the computer thus giving a consumer several design options to pick from.

The next step involves a consumer providing feedback to the visual models 172 that have been generated by the computer. If the consumer is pleased with the visual models that he or she has viewed, then the co-creation process has been a success and perhaps no further design work may need to be conducted in this session. However, if the consumer would like to they may provide to the computer, yet additional feedback which may result in the computer generating yet additional revised visual models 174 for the consumer to then again review. If the consumer is now satisfied with the models she has co-designed, then she may be prompted to complete a consumer survey 176. Once the consumer survey has been completed, the computer will generate metrics of the consumer's design experience 178 which effectively report out to researchers, developers, designers, and marketers the entirety of the design experience that the consumer experienced. Once this step is completed, the new product design team now has a better direction from consumers of their preferred design attributes 180 for a given new product.

It will be appreciated that the aforementioned process may be modified to have some steps removed, or have additional steps added, all of which is deemed to be within the spirit of the present invention.

Even though the present invention has been described in detail with reference to specific embodiments, it will be appreciated that the various modifications and changes can be made to these embodiments without departing from the scope of the present invention as set forth in the claims. Accordingly, the specification and the drawings are to be regarded as an illustrative thought instead of merely a restrictive thought of the scope of the present invention.

What is claimed as new and desired to be protected by Letters Patent of the United States is:

1. A method for creating new products using a co-design process, the method comprising the steps of:
creating an event for consumers to be invited into and participate in a process of designing a product that is yet to be designed or marketed;
providing a computer for a consumer to interact with during a design event;
logging the consumer onto the computer;
providing a data base to collect data from the consumer;
inputting consumer profile information into the data base of the computer;
providing instructions to the consumer for the consumer to follow and informing the consumer about the co-design process;
generating visual images of products for the consumer to consider;
consumer selects preferred choice of the visual images of products by inputting their choice into the computer;
computer generates additional visual images of products for consumer to consider;
consumer selects more preferred choices and inputs their choice into the computer; and
computer generates a computer model illustrating a preferred product design having attributes of a product that are desirable to the consumer.

2. The method for creating new products using a co-design process as claimed in claim 1, further comprising the step of the consumer completing a survey by entering data into the computer.

3. The method for creating new products using a co-design process as claimed in claim 1, further comprising the step of rewarding the consumer for participating in the co-design process.

4. The method for creating new products using a co-design process as claimed in claim 1, further comprising the step of accessing the database and aggregating the data that has been collected from the consumer, and providing this information electronically to a client that is interested in learning about how a consumer has reacted during the co-design process.

5. The method for creating new products using a co-creation process as claimed in claim 1, further comprising the step of connecting the consumer with a product designer and the consumer expressing their design choices to the designer, the designer then being influenced by those design choices, the designer then creates a model showing a product having consumer's design choices.

6. The method for creating new products using a co-design process as claimed in claim 1, further comprising the step of electronically capturing a consumer's reaction to a visual image that has been shown to the consumer, and providing that reaction to a designer or marketer.

7. The method for creating new products using a co-creation process as claimed in claim 1, further comprising the step of the computer processing the data in the data base to provide metrics to a client, the metrics show a client the data that was received from consumers.

8. The method for creating new products using a co-creation process as claimed in claim 1, wherein said step of generating visual images of products for the consumer to consider includes providing a computer that accesses a database, said database has images of products that have been created by a designer.

9. A method for creating new products, the method comprising the steps of:
providing a website with a dashboard for a consumer to use to navigate the website, the dashboard having options for a consumer to select;
providing a computer for a consumer to log onto the website, the website having an interface that is secured to a cloud for storing data;
recruiting consumers to participate in a co-design process whereby new product ideas can be generated;
logging a consumer onto the website;
generating a consumer profile by the consumer inputting their personal data through the website;
a consumer inputting product feature preferences into the computer for potential consideration by a designer who is designing a new product;
generating at least one computer model that includes product feature preferences that are preferred by the consumer;
completing a consumer survey and processing data from the survey; and
providing metrics to a client that shows the results of the consumer survey.

10. The method for creating new products as claimed in claim 9, further comprising the step of a consumer interacting with a designer to provide the consumer's design influences to the designer.

11. The method for creating new products as claimed in claim 9, further comprising the step of hosting the data that is collected from the consumer in a cloud.

12. The method for creating new products as claimed in claim 9, further comprising the step of the consumer providing design influences about the computer model that was generated by the computer, said design influences are entered into the website.

13. A digital tool for a marketer to use that allows for consumer input early into the design process of a new product, the digital tool comprising:
a software program that when operated creates a human interface for use in co-creating a new consumer product, said human interface can be a dashboard with at least one screen for receiving consumer information;
a computer that is operable to execute said software program; and
a server for hosting data, said computer is connected to said server.

14. The digital tool as claimed in claim 13, wherein said consumer information includes personal profile information or product design choice preferences.

15. The digital tool as claimed in claim 13, wherein said software program captures data from the consumer, aggregates the data and provides summary information for others to consider so that they can learn more about the consumer.

16. The digital tool as claimed in claim 13, wherein said software program processes the consumer information and takes design cues from the consumer, said program then causes product images to be illustrated on the computer which are representative of design preferences of the consumer.

17. The digital tool as claimed in claim 13, wherein said dashboard includes a sketch screen that is interactive with the consumer and allows the consumer to design a product.

18. The digital tool as claimed in claim 13, wherein said dashboard includes tools to allow a consumer to provide product design preferences, the software then responds to those product design preferences by generating new product images for the consumer to react to and provide further feedback through the dashboard.

19. The digital tool as claimed in claim 13, wherein said computer is a tablet, a PDA, a desk top, or other digital computing device.

20. The digital tool as claimed in claim 13, wherein a designer is connected to the server and can communicate with the consumer about the consumer's design preferences.
